(19) United States
(12) Patent Application Publication
(10) Pub. No.: US 2018/0241778 A1
(43) Pub. Date: Aug. 23, 2018

(54) DEVICE TO PERFORM POLICY VERIFICATION

(71) Applicant: QUALCOMM Incorporated, San Diego, CA (US)

(72) Inventors: Philip Hawkes, Valley Heights (AU); David Hartley, Berlin (AU)

(21) Appl. No.: 15/439,769

(22) Filed: Feb. 22, 2017

(51) Int. Cl. H04L 29/06; H04L 9/32

(52) U.S. Cl. CPC H04L 63/20; H04L 63/0853; H04L 9/3242; H04L 9/3297

(57) ABSTRACT

Aspect may relate to a device that comprises an interface and a processor. The interface may be configured to: obtain a statement from an asserting party exercising an authorization. The processor may be coupled to the interface and the processor may be configured to: implement an evaluator to evaluate the statement from the asserting party with policy verification instructions to determine if the asserting party was authorized to issue the statement.

### BACKGROUND

### Field

The present invention relates to a device that performs policy verification.

### Relevant Background

For computing devices that communicate with one another (e.g., device to device, server to client, Internet of Thing devices (IoTs), Machine-to-Machine devices (M2M), etc.)), there is a need for machine-readable authorizations that scopes interactions within an open ecosystem with multiple Authorities and that is robust to changing policies and changing boundaries of responsibility and regulation.

However, existing authorization frameworks, (e.g., X.509) assume that a relying party will always correctly implement the specific policy verification method for the policy under which an assertion was issued. This approach does not easily allow changes in policy.

Moreover, the existence of multiple implementations of the same policy verification method introduces high risk of errors and the policy verification logic may be faulty/incomplete/missing such that an asserting party may issue a statement that exceeds their authorization. For example, the X.509 policy verification method includes name constraints that is implemented with different errors in different browsers.

### SUMMARY

Aspect may relate to a device that comprises an interface and a processor. The interface may be configured to: obtain a statement from an asserting party exercising an authorization. The processor may be coupled to the interface and the processor may be configured to: implement an evaluator to evaluate the statement from the asserting party with policy verification instructions to determine if the asserting party was authorized to issue the statement.

### BRIEF DESCRIPTION OF THE DRAWINGS

FIG. 1 is a diagram of a system in which embodiments may be practiced.

FIG. 2 is a diagram of one example of operations of the authority, the asserting party, and the relying party.

FIG. 3 is a diagram showing different examples of policy verification.

FIG. 4 is a diagram of another example of operations of the authority, the asserting party, and the relying party.

FIG. 5 is a diagram of another example of operations of the authority, the asserting party, and the relying party.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

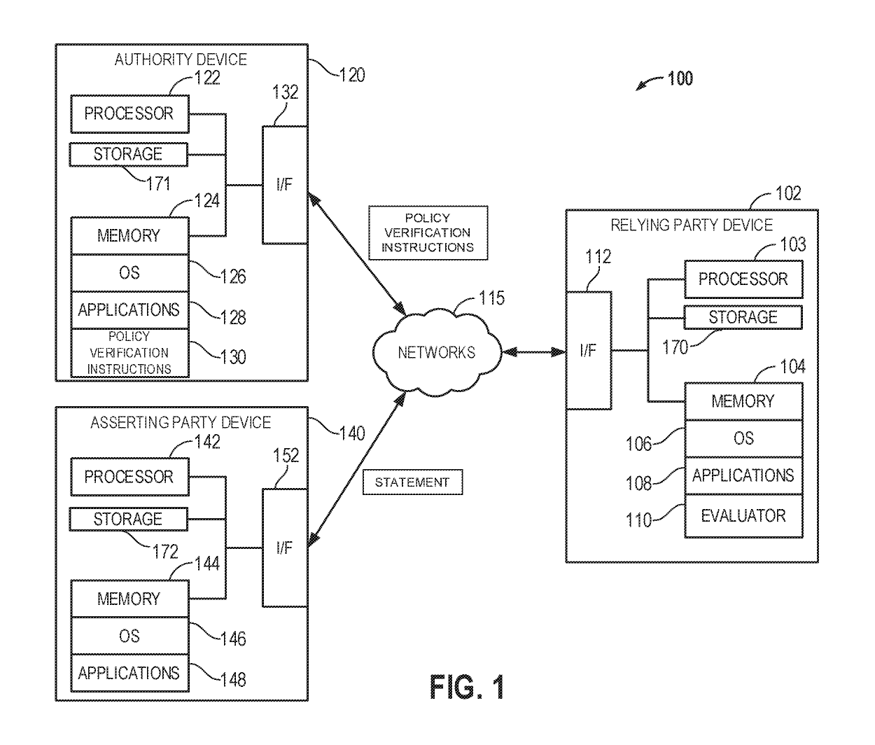

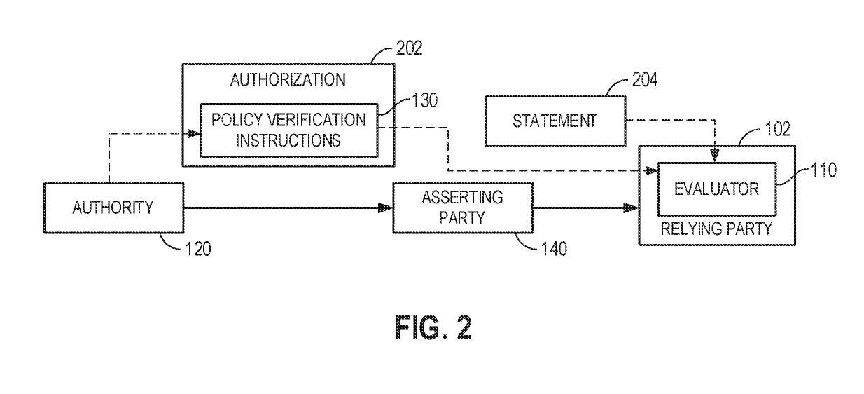

With reference to FIGS. 1 and 2, a relying party device 102, an authority device 120, and an asserting party device 140 may be in communication with one another or other devices, respectively, via networks 115. It should be appreciated that networks 115 may include any type of wireless or wired networks and/or combinations thereof, including cellular networks, wide area networks, local area networks, Internet, etc.

As an example, relying party device 102, authority device 120, and asserting party device 140 may comprise hardware elements that can be electrically coupled via a bus (or may otherwise be in communication, as appropriate). The hardware elements may include: one or more processors 103, 122, and 142, respectively, including without limitation one or more general-purpose processors and/or one or more special-purpose processors (such as digital signal processing chips, graphics acceleration processors, and/or the like), to implement functions to be hereafter described.

Also, it should be appreciated that relying party device 102, authority device 120, and asserting party device 140 may include: input devices (e.g., keyboard, keypad, touchscreen, mouse, etc.); output devices such as speakers, etc.; display devices (e.g., screens, touch screens, etc.); sensors (e.g., a clock, an ambient light sensor (ALS), a biometric sensor, an accelerometer, a gyroscope, a magnetometer, an orientation sensor, a weather sensor (e.g., temperature, wind, humidity, barometric pressure, etc.), a Global Positioning Sensor (GPS), an infrared (IR) sensor, a proximity sensor, a near field communication (NFC) sensor, a fingerprint sensor, a camera, a microphone, or any type of sensor. As should be appreciated relying party device 102, authority device 120, and asserting party device 140 may be any type of computing device that can communicate with other computing devices.

In one embodiment, processors 103, 122, and 142 of relying party device 102, authority device 120, and asserting party device 140 may control applications 108, 128, and 148 in conjunction with operating systems 106, 126, and 146, respectively. In one embodiment, as will be described hereafter in more detail, relying party device 102 may operate an evaluator 110.

Further, relying party device 102, authority device 120, and asserting party device 140 may further include (and/or be in communication with) one or more non-transitory storage devices or non-transitory memories 170, 171, and 172, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Relying party device 102, authority device 120, and asserting party device 140 may also include communication subsystems and/or interfaces 112, 132, and 152, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communications subsystems and/or interfaces 112, 132, and 152 may permit data to be exchanged with each other and other devices through networks 115 (wireless and/or wired), as previously described.

In some embodiments, relying party device 102, authority device 120, and asserting party device 140 may each include a working memory 104, 124, and 144, respectively, which can include a RAM or ROM device, as described above. Relying party device 102, authority device 120, and asserting party device 140 may include firmware elements, software elements, shown as being currently located within the working memories including operating systems, applications, device drivers, executable libraries, and/or other code. In some embodiments, applications, programs, codes, etc., may be designed to implement methods, and/or configure systems, to implement embodiments, as described herein. For example, in one embodiment, as will be described hereafter in more detail, relying party device 102 may operate an evaluator 110. Merely by way of example, one or more procedures described with respect to the method(s) discussed below may be implemented as code and/or instructions executable by a device (and/or a processor within a device) to be implemented by relying party device 102, authority device 120, and/or asserting party device 140; in an aspect, then, such code and/or instructions can be used to configure and/or adapt the devices to perform one or more operations in accordance with the described methods, according to embodiments described herein. Set of these instructions and/or code may be stored on a non-transitory computer-readable storage medium, such as the storage device(s) described above. It will be apparent to those skilled in the art that substantial variations may be made in accordance with specific requirements. For example, customized hardware might also be used, and/or particular elements might be implemented in hardware, firmware, software, or combinations thereof, to implement embodiments described herein.

As previously described, each of relying party device 102, authority device 120, and asserting party device 140 may be any type of device, computer, smartphone, tablet, cellular telephone, wearable device, SoC, Internet of Things (IoT) device, etc. Further, relying party device 102, authority device 120, and asserting party device 140 may exchange data with each other and other devices through networks 115 (wireless and/or wired), as previously described.

Embodiments to be hereafter described may be related to using policy verification instructions 130 and a policy-independent evaluator 110 in relying party 102 to ensure consistent, yet flexible, policy verification logic. As will be described, authority 120 encodes the policy verification method in policy verification instructions 130 that is bound to an authorization 202 that is transmitted to relying party 102. An asserting party 140 may issue a statement 204 to exercise an authorization. The relying party 102 evaluates the statement 204 with the policy verification instructions utilizing the evaluator 110 to determine if the statement 204 complies with the policy verification method, in which case the statement is said to be valid and the asserting party is determined to have been authorized to issue the statement.

In one embodiment, the relying party 102 includes an interface 112, a processor 103, and a memory 104 that includes an evaluator 110, as has been described. In one embodiment, processor 103 may include the evaluator 110. As one example, interface 112 may obtain: policy verification instructions 130 bound to an authorization 202 transmitted by authority device 120 through interface 132 and networks 115 to implement a policy verification method to determine authorization of asserting parties that issue statements. Further, relying party 102 through interface 112 may obtain a statement 204 transmitted by asserting party 140 through interface 152 and networks 115. Processor 103 of relying party 102 may implement an evaluator 110 to evaluate the statement 204 from the asserting party 140 with the policy verification instructions 130 to determine if the statement is valid. If the statement 204 is determined to be valid, then a function by the relying party 102 may be allowed to be performed. It should be appreciated that the terminology obtain, receive, provision, etc., may be used interchangeably. For example, the relying party 102 may receive or obtain a statement 204 from the asserting party 140. As an example, the statement 204 may be provisioned on the relying party 110. Similarly, the authorization 202 including the policy verification instructions for use by the evaluator 110 may be obtained or received from the authority 120 or may be provisioned on the relying party 102.

It should be appreciated that policy verification instructions 130 and the evaluator 110 to evaluate the statement 204 may utilize scripting language or coding that may be a dynamic high-level general-purpose programming language, in which the script, may be a relatively small program for fast run-time execution and may be related to domain-specific languages for particular environments. Therefore, the policy verification instructions 130, statement 204, and evaluator 110 may provide an efficient way to determine the validity of a statement 204, while remaining robust to changing policies and changing boundaries of responsibility and regulation.

There are many different examples of environments in which the evaluator 110 of the relying party 102 may be utilized to determine whether the asserting party 140 was authorized or not to issue the statement 204. For example, statement 204 from asserting party 140 may include a handshake and the asserting party 140 may be a server. As another example, the statement 204 may include an access request from an asserting party 140 to access a feature managed by the relying party 102 (e.g., a home automation company (the asserting party 104)) may request access to doors (features) controlled by the relying party 102 (e.g., the home owner)).

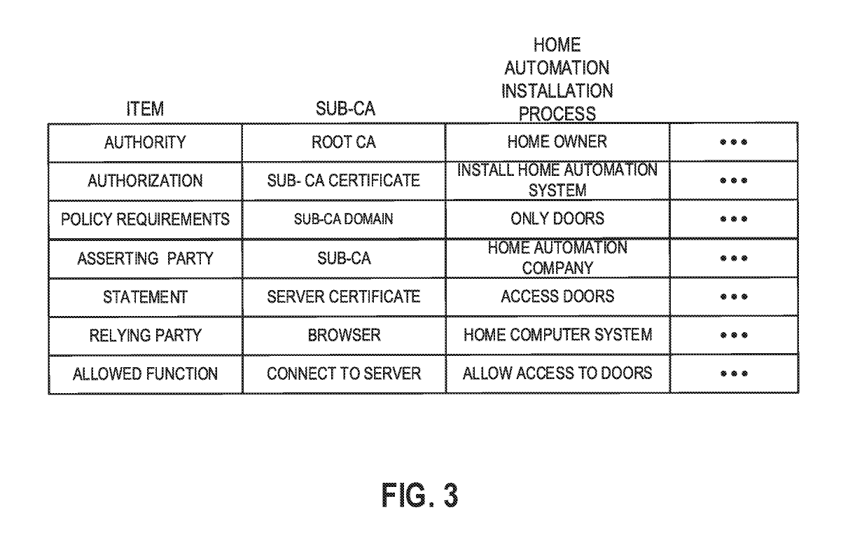

With additional reference to FIG. 3, some examples will be described. As one example, a subordinate certificate authority (sub-CA) implementation may be illustrated. In this example, the following system may include: authority 102 being a root CA to issue a sub-CA certificate (authorization 202 including policy verification instructions) authorizing the sub-CA (asserting party 140) to issue certificates within some sub-domain (e.g., *.example.domain) (policy requirements). In this example, the asserting party 140 issues a server certificate (statement 204) to a server. A browser (relying party 204) receives the sub-CA certificate (authorization 202) and server certificate (statement 204) when it authenticates the server, and verifies that the server certificate subject identifier (e.g., server name) is within the sub-CA domain of authority (e.g., *.example.domain). If the browser authenticates the server successfully, then an allowed function may be performed, such as, the browser connecting to the server. It should be appreciated that the policy verification instructions may encode parameters representing policy requirements on the sub-CA domain of authority (e.g., *.example.domain) and that that the policy verification instructions may implement verification methods related to the sub-CA domain of authority. Further, for example, the browser may perform certificate validation by running the policy verification instructions with the evaluator 110 related to the sub-CA domain of authority including checking that the server certificate subject identifier (e.g., server name) is within parameters representing policy requirements on the sub-CA domain of authority (e.g.,. server name matches pattern: *.example.domain from the sub-CA certificate).

Another example may refer to a home automation installation process. In this example, the following components may include: authority 120 being a homeowner; authorization 202 being to install a home automation system; policy requirements implemented in the policy verification instructions may restrict access to include only doors being altered and may restrict such other items as allowed times; asserting party 140 may be the home automation company; statement 204 may be a request to access doors; relying party 102 may be a home computer system of the homeowner; and the allowed function may be to allow access to doors components (e.g., open doors) to allow the home automation company to install the home automation system to doors. Therefore, in this example, the home automation company is the asserting party and the statement is a request to the relying party's home computer to allow access to doors (and may include other items such as time/timestamps). The relying party/home computer system evaluates the statement/access request with the policy verification instructions, in the authorization 202, utilizing the evaluator 110. If the statement/access request is determined to be valid by the evaluator 110 of the relying party/home computer system, the home automation company is determined to have been authorized and access to the doors (e.g., doors being opened) is provided to allow for installation of the home automation system (allow function). If the statement/access request is determined to be not valid by the evaluator 110 of the relying party/home computer system, the home automation company is determined to have not been authorized and access to the doors (e.g., doors being opened) is not allowed.

In an alternative example of the above system, the statement 204 may be a digital signature in a TLS handshake which is evaluated by the evaluator 110 of the relying party's home computer during the establishing of a TLS or DTLS session, and the request to access the doors is later submitted within the established TLS or DTLS session. In this case, if the statement/TLS handshake digital signature is determined to be valid by the evaluator 110 of the relying party/home computer system, the home automation company is determined to have been authorized and access to the doors (e.g., doors being opened) will be provided when requested.

It should be appreciated that these are only examples and that a wide variety of different examples and different environments in which an evaluator 110 of a relying party device 102 may be utilized to determine whether a statement 204 is valid. In many cases, the validity of a statement 204 determines whether an asserting party device 140 should be authorized or not authorized to perform a function or process with the relying party device 102.

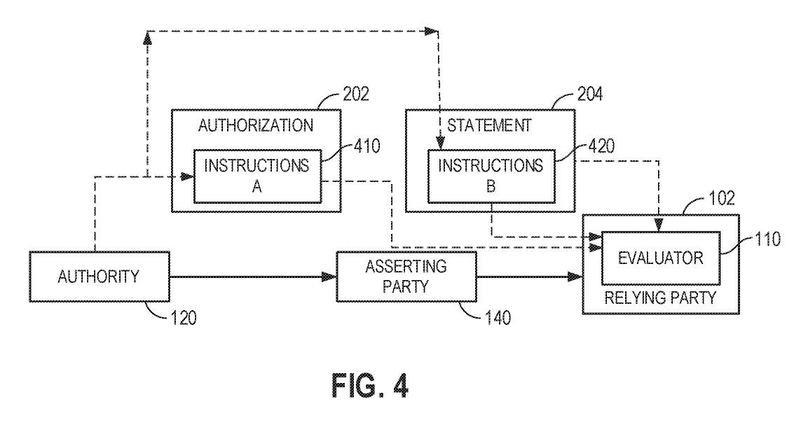

Also, various different types of implementations may be utilized. For example, with additional reference to FIG. 4, one type of implementation may involve having the policy verification instructions be divided into multiple instructions. As one example, a first portion of the instructions (instructions A 410) may be provided in the authorization 202 from the authority 120 and a second portion of the instructions (instructions B 420) may be provided in the statement 204 from the asserting party 140. Alternatively, the second portion of the instructions may be stored elsewhere.

Further, as one example, instructions A 410 of the authorization 202 from the authority 120 may include a hash value and may identify a hash function and instructions B 420 of the statement 204 from the asserting party 140 may satisfy instructions A in the evaluator 110 of relying party 102 by hashing to the specified hash value. In this way, instructions B 420 of statement 204 implements the policy verification method. Alternatively, instructions B may be stored somewhere and retrieved by the relying party 102 to verify the statement 204. As another example, the policy verification instructions may be split over instructions A 410 from the authority 120 and instructions B 420 in the statement 204 from the relying party 140 in which: instructions A include some of the policy verification instructions in addition to a hash value; and instructions B provide the remaining policy verification instructions. Also, in some embodiments, the statement 204 includes time stamps, to be compared against the time when the statement is validated, and/or other types of data for use in statement validation by the relying party 102 through evaluator 110.

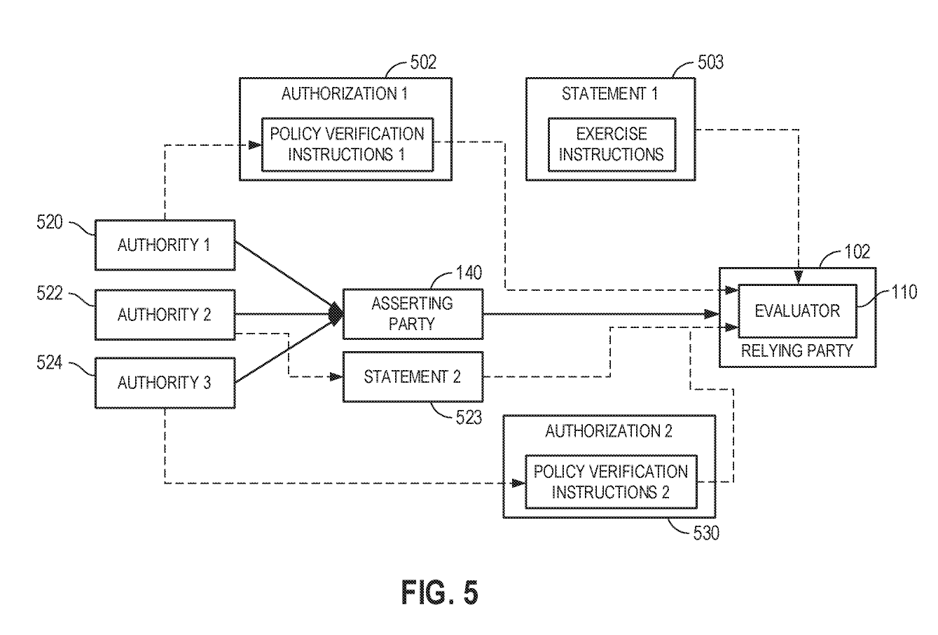

In some embodiments, multiple authorities may be utilized. Each of the multiple authorities, as well as the asserting party and relying party to be described may have similar structural and functional device characteristics, as previously described, and are additional examples. For example, with additional reference to FIG. 5, authority 1 520 may be a homeowner and may issue an authorization to an asserting party 140 (e.g., an installer) to install home automation at their home. Authority 1 520 (homeowner) may transmit an authorization 1 502 including a policy verification instructions 1 to relying party 102 (e.g., the homeowner's computer system) such that the homeowner's computer system may implement evaluator 110 to determine if the statement 1 530 from the asserting party 140 (the installer) is valid such that the installer can proceed with performing the home automation function (e.g., installing computer controlled alarms). However, in this example, policy verification instructions 1 of authorization 1 502 to be implemented by evaluator 110 of the relying party 102 may further require an authorization 2 530 including policy verification instructions 2 from another authority 3 524 (e.g., home automation association) thereby requiring that the home automation association has authorized home installer 140 with the authority to install the computer controlled alarms. If the evaluator 110 of the homeowner's computer system cannot verify both the statement 503 from the installer 140 and the authorization 530 from the home automation association 524 then the installer will not be validated and authorized such that installer is not allowed to proceed with the installation of the computer controlled alarms. In one embodiment, installer 140 in statement 503 may utilize exercise instructions which glues together policy verification instructions 1 and authorization 2 530 for processing by evaluator 110.

As another example, authority 1 520 may be a homeowner and may issue an authorization to an asserting party 140 (e.g., a visitor) to grant access to certain media at their home. In this example, authority 1 520 (homeowner) may transmit an authorization 1 502 including policy verification instructions 1 to relying party 102 (e.g., the homeowner's media system) such that the homeowner's media system may implement evaluator 110 to determine if the statement 1 530 from the asserting party 140 (the visitor) is valid such that the visitor can access media from the homeowner's media system. However, in this example, policy verification instructions 1 of authorization 1 502 to be implemented by evaluator 110 of the relying party 102 may further require statement 2 523 from another authority 2 522 (e.g., proof of age and/or time) thereby requiring the proof of age and/or time be confirmed to allow the visitor to access the homeowner's media system. If the evaluator 110 of the homeowner's computer system cannot verify both the statement 503 from the visitor 140 and statement 2 530 (e.g., proof of age and/or time/timestamp) then the visitor will not be validated and authorized such that visitor is not allowed to access the homeowner's media system. In one embodiment, visitor 140 in statement 1 503 may utilize exercise instructions which glue together policy verification instructions 1 and statement 2 523 for processing by evaluator 110.

As has been described previously in detail, statements from asserting parties 140 may include one or more statement parameters (e.g., number, timestamp, name, age, region, floor, room, etc.). Further, additional context parameters such as the current time, current location, current position and current orientation may be used as an input to the evaluator 110. Also, as previously described, authorizations from authorities may include various types of authorization parameters (e.g., number, timestamp, name, age, region, floor, room, etc.) to be evaluated with the policy evaluation instructions of the evaluator 110.

The previously described methodology provides many distinctions over prior methods to perform policy verification. For example, relying parties may reach the same conclusion based upon the same inputs. Utilizing the previously described policy verification methods, trusted parties are allowed to confirm statement authorization for relying parties. Further, these methods support changing policies, changing organization structures, and changing boundaries. Authorities can update policies quickly and easily by updating the policy verification instructions. Moreover, these policy verification methods support processing authorizations in various domains. These policy verification methods allow for more flexibility in policy verification logic. Also, fewer resources are required by a relying party to accommodate multiple policies. For example, only a single evaluator 110 of a relying party may accommodate multiple different polices. Further, fewer implementations of policy verification logic result in a lower risk of errors and omissions.

It should be appreciated that the previously described policy verification methods are designed for open and interoperable ecosystems. In particular, aspects of the previously described methodology may be particularly suitable for internet of things (IoT) device authorization management and machine to machine (M2M) authorization management. Previous examples have been given for server/client device authorization management, home owner device to home automation company device authorization management, home owner device to installation company device authorization management, and home owner device to visitor media access authorization management. But these are only a few limited number of examples of device to device policy verification/authorization management, and the possible number of example are almost infinite.

In particular, for IoT/M2M authorization management, the previously described verification/authorization management techniques may be applicable for a wide variety of different implementations. The previously described IoT/M2M authorization management techniques are applicable to many open ecosystems with multiple authorities that according to the embodiments of the previously described methodology can accommodate robustly changing policies, and changing/crossing boundaries of responsibilities and regulations.

For example, these previously described IoT/M2M authorization management techniques may be particular applicable to ecosystems including: electronic health (eHealth), home IoT, smarty city, automotive, etc.

For example, as to eHealth, policies that can be managed, updated, and verified may relate to: control of devices—sensors, systems, and configurations; access to health records; transfer of care and home care providers (authorization of people (and their devices)) from other domains; emergency over-ride and changing/crossing boundaries of responsibility/regulation (e.g., accessing health records while in another country); and change in policy (e g , family/friends, care providers, legislation, etc.).

For example, as to home IoT, policies that can be managed, updated, and verified may relate to: control of devices—sensors, systems, and configurations; access to home (privacy enforcement); tenants, visitors, visiting workers (authorization of people (and their devices)); emergency over-ride (fire protection); changing/crossing boundaries of responsibility/regulation (e.g., leased properties); and change in policy (e.g., changes in family/friends, workers, visitors, re-sale, etc.).

For example, as to smart city implementations, policies that can be managed, updated, and verified may relate to: control of devices—sensors, systems, and configurations; control of access (sharing information across organizations); emergency over-ride (e.g., traffic management); changing/crossing boundaries of responsibility/regulation (e.g., organization changes); and change in policy (e.g., changes in law, legislation, etc.).

For example, as to automotive implementations, policies that can be managed, updated, and verified may relate to: control of equipment/devices—sensors, systems, and configurations; control of access (maintenance, diagnostics, trip history, etc.); emergency over-ride (e.g., changing path, turning automobile off, etc.); changing/crossing boundaries of responsibility/regulation (e.g., driving across border); and change in policy (e.g., changes in law, legislation, re-sale, etc.).

These previously described IoT/M2M authorization management techniques are only examples and the previously described methods may be applicable to many open ecosystems with multiple authorities that according to the embodiments of the previously described methodology can accommodate robustly changing policies, and changing/crossing boundaries of responsibilities and regulations.

It should be appreciated that aspects of the previously described processes may be implemented in conjunction with the execution of instructions by a processor of devices (e.g., devices 102, 120, 140, etc.), as previously described. Particularly, circuitry of the devices, including but not limited to processors, may operate under the control of a program, routine, application, or the execution of instructions to execute methods or processes in accordance with embodiments described (e.g., the processes and functions of FIGS. 2-5). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a SoC, a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A device comprising:
an interface configured to:
obtain a statement from an asserting party exercising an authorization; and
a processor coupled to the interface, the processor configured to:
implement an evaluator to evaluate the statement from the asserting party with policy verification instructions to determine if the asserting party was authorized to issue the statement.

2. The device of claim 1, wherein the interface is further configured to obtain an authorization containing the policy verification instructions to implement a policy verification method for a policy.

3. The device of claim 2, wherein if the statement is determined to be compliant with the policy verification method, then a function is allowed to be performed.

4. The device of claim 1, wherein the statement includes at least one statement parameter.

5. The device of claim 4, wherein the at least one statement parameter includes at least one statement time stamp.

6. The device of claim 1, wherein at least one context parameter is used as an input to the evaluator.

7. The device of claim 6, wherein the at least one context parameter includes at least one of current time, current location, current position or current orientation.

8. The device of claim 1, wherein the authorization includes at least one authorization parameter to be evaluated with the policy evaluation instructions.

9. The device of claim 8, wherein the at least one authorization parameter includes at least one authorization time stamp.

10. The device of claim 1, wherein the policy verification instructions comprise a hash value.

11. The device of claim 10, wherein the policy verification instructions further comprise a hash function.

12. The device of claim 1, wherein the policy verification instructions comprise a first portion of the policy verification instructions obtained from an authority and a second portion of the policy verification instructions obtained from the asserting party.

13. The device of claim 1, wherein the policy verification instructions comprise multiple policy verification instructions obtained from different authorities.

14. A method comprising:
obtaining a statement from an asserting party exercising an authorization; and
evaluating the statement from the asserting party with policy verification instructions to determine if the asserting party was authorized to issue the statement.

15. The method of claim 14, further comprising, obtaining an authorization containing the policy verification instructions to implement a policy verification method for a policy.

16. The method of claim 15, wherein if the statement is determined to be compliant with the policy verification method, then a function is allowed to be performed.

17. The method of claim 14, wherein the statement includes at least one statement parameter.

18. The method of claim 17, wherein the at least one statement parameter includes at least one statement time stamp.

19. The method of claim 14, wherein at least one context parameter is used as an input.

20. The method of claim 19, wherein the at least one context parameter includes at least one of current time, current location, current position or current orientation.

21. The method of claim 14, wherein the authorization includes at least one authorization parameter to be evaluated with the policy evaluation instructions.

22. The method of claim 21, wherein the at least one authorization parameter includes at least one authorization time stamp.

23. The method of claim 14, wherein the policy verification instructions comprise a hash value.

24. The method of claim 23, wherein the policy verification instructions further comprise a hash function.

25. The method of claim 14, wherein the policy verification instructions comprise a first portion of the policy verification instructions obtained from an authority and a second portion of the policy verification instructions obtained from the asserting party.

26. The method of claim 14, wherein the policy verification instructions comprise multiple policy verification instructions obtained from different authorities.

27. A non-transitory computer-readable medium including code that, when executed by a processor of a device, causes the processor to:
obtain a statement from an asserting party exercising an authorization; and
evaluate the statement from the asserting party with policy verification instructions to determine if the asserting party was authorized to issue the statement.

28. The computer-readable medium of claim 27, further comprising code to obtain an authorization containing the policy verification instructions to implement a policy verification method for a policy.

29. The computer-readable medium of claim 28, wherein if the statement is determined to be compliant with the policy verification method, then a function is allowed to be performed.

30. The computer-readable medium of claim 27, wherein the statement includes at least one statement parameter.

31. The computer-readable medium of claim 30, wherein the at least one statement parameter includes at least one statement time stamp.

32. The computer-readable medium of claim 27, wherein at least one context parameter is used as an input.

33. The computer-readable medium of claim 32, wherein the at least one context parameter includes at least one of current time, current location, current position or current orientation.

34. The computer-readable medium of claim 27, wherein the authorization includes at least one authorization parameter to be evaluated with the policy evaluation instructions.

35. The computer-readable medium of claim 34, wherein the at least one authorization parameter includes at least one authorization time stamp.

36. The computer-readable medium of claim 27, wherein the policy verification instructions comprise a hash value.

37. The computer-readable medium of claim 36, wherein the policy verification instructions further comprise a hash function.

38. The computer-readable medium of claim 27, wherein the policy verification instructions comprise a first portion of the policy verification instructions obtained from an authority and a second portion of the policy verification instructions obtained from the asserting party.

39. The computer-readable medium of claim 27, wherein the policy verification instructions comprise multiple policy verification instructions obtained from different authorities.

40. A device comprising:
means for obtaining a statement from an asserting party exercising an authorization; and
means for implementing an evaluator to evaluate the statement from the asserting party with policy verification instructions to determine if the asserting party was authorized to issue the statement.

41. The device of claim 40, further comprising means for obtaining an authorization containing the policy verification instructions to implement a policy verification method for a policy.

42. The device of claim 41, wherein if the statement is determined to be compliant with the policy verification method, then a function is allowed to be performed.

43. The device of claim 40, wherein the statement includes at least one statement parameter.

44. The device of claim 43, wherein the at least one statement parameter includes at least one statement time stamp.

45. The device of claim 40, wherein at least one context parameter is used as an input to the evaluator.

46. The device of claim 45, wherein the at least one context parameter includes at least one of current time, current location, current position or current orientation.

47. The device of claim 40, wherein the authorization includes at least one authorization parameter to be evaluated with the policy evaluation instructions.

48. The device of claim 47, wherein the at least one authorization parameter includes at least one authorization time stamp.

49. The device of claim 40, wherein the policy verification instructions comprise a hash value.

50. The device of claim 49, wherein the policy verification instructions further comprise a hash function.

51. The device of claim 40, wherein the policy verification instructions comprise a first portion of the policy verification instructions obtained from an authority and a second portion of the policy verification instructions obtained from the asserting party.

52. The device of claim 40, wherein the policy verification instructions comprise multiple policy verification instructions obtained from different authorities.
